(19) United States
(12) Patent Application Publication
(10) Pub. No.: US 2025/0213898 A1
(43) Pub. Date: Jul. 3, 2025

(54) SYSTEMS AND METHODS FOR DETECTING AND REPORTING FIRES SURROUNDING AN AUTONOMOUS VEHICLE

(71) Applicant: Torc Robotics, Inc., Blacksburg, VA (US)

(72) Inventors: Joseph R. Fox-Rabinovitz, Blacksburg, VA (US); Pablo Smith, Blacksburg, VA (US); William Davis, Blacksburg, VA (US); Akshay Pai Raikar, Blacksburg, VA (US); Mihir Deshingkar, Blacksburg, VA (US); Justin Yurkanin, Blacksburg, VA (US)

(21) Appl. No.: 18/398,687

(22) Filed: Dec. 28, 2023

(51) Int. Cl. A62C 3/02; B60W 60/00

(52) U.S. Cl. CPC A62C 3/0271; B60W 60/0025; B60W 2555/00

(57) ABSTRACT

A method for detecting and reporting fires by an autonomous vehicle. The method includes receiving, from one or more sensors, at least one sensor signal representing one or more fire-related conditions surrounding the autonomous vehicle, and identifying one or more fire-indicative conditions surrounding the autonomous vehicle based on the one or more fire-related conditions. The method also includes generating a fire detection signal based at least on the one or more fire-indicative conditions, a location of the one or more fire-indicative conditions, and a location of the autonomous vehicle, and transmitting the fire detection signal to an external receiver.

### TECHNICAL FIELD

The field of the disclosure relates generally to autonomous vehicles and, more specifically, to systems and methods for use in detecting and reporting fires using sensor data of conditions surrounding an autonomous vehicle.

### BACKGROUND OF THE INVENTION

At least some known autonomous vehicles may implement four fundamental technologies in their autonomy software system: perception, localization, behaviors and planning, and motion control. Perception technologies enable an autonomous vehicle to sense and process its environment. Perception technologies process a sensed environment to identify and classify objects, or groups of objects, in the environment, for example, pedestrians, vehicles, or debris. Localization technologies determine, based on the sensed environment, for example, where in the world, or on a map, the autonomous vehicle is. Localization technologies may process features in the sensed environment to correlate, or register, those features to known features on a map. Additionally, localization technologies may use data received from sensors and/or various odometry information sources to generate an estimated vehicle location in the world.

Behaviors and planning technologies determine how to move through the sensed environment to reach a planned destination, processing data representing the sensed environment and localization or mapping data to plan maneuvers and routes to reach the planned destination. Motion control technologies translate the output of behaviors and planning technologies into concrete commands to the vehicle via the vehicle interface provided by the internal electronic control unit (ECU).

One element of perception for autonomous vehicles is detection and identification of conditions surrounding the autonomous vehicle. During operation, a condition may be detected by the autonomous vehicle that may make further operation of the autonomous vehicle unsafe and/or may pose a risk to the area surrounding the autonomous vehicle. For example, a fire-related condition may be detected in one or more areas surrounding the vehicle. However, without appropriate behaviors and planning input into motion control, an autonomous vehicle that detects these conditions may be unable to safely continue movement towards a planned destination. Additionally, without transmitting a fire detection signal to an external receiver to notify a local authority and/or a control center, an autonomous vehicle that detects these conditions may be unable to send alerts of unsafe conditions. Accordingly, there exists a need for systems and methods for detecting and reporting fires using sensor data of conditions surrounding an autonomous vehicle.

This section is intended to introduce the reader to various aspects of art that may be related to various aspects of the present disclosure described or claimed below. This description is believed to be helpful in providing the reader with background information to facilitate a better understanding of the various aspects of the present disclosure. Accordingly, it should be understood that these statements are to be read in this light and not as admissions of prior art.

### SUMMARY OF THE INVENTION

The embodiments described herein relate to a system for detecting and reporting fires by an autonomous vehicle. The system includes a fire detection system and a processing system. The fire detection system includes one or more sensors oriented outwards from an exterior of the autonomous vehicle to collect data in one or more areas surrounding the autonomous vehicle. The processing system includes a processor and a memory device, the memory device storing instructions that when executed cause the processor to receive, from the one or more sensors, at least one sensor signal representing one or more fire-related conditions surrounding the autonomous vehicle, identify one or more fire-indicative conditions surrounding the autonomous vehicle based on the one or more fire-related conditions, generate a fire detection signal based at least on the one or more fire-indicative conditions, a location of the one or more fire-indicative conditions, and a location of the autonomous vehicle, and transmit the fire detection signal to an external receiver.

The embodiments described herein also relate to a method for detecting and reporting fires by an autonomous vehicle. The method includes receiving, from one or more sensors, at least one sensor signal representing one or more fire-related conditions surrounding the autonomous vehicle, and identifying one or more fire-indicative conditions surrounding the autonomous vehicle based on the one or more fire-related conditions. The method also includes generating a fire detection signal based at least on the one or more fire-indicative conditions, a location of the one or more fire-indicative conditions, and a location of the autonomous vehicle, and transmitting the fire detection signal to an external receiver.

The embodiments described herein further relate to a processing system for detecting and reporting fires by an autonomous vehicle. The processing system includes a processor and a memory device, the memory device storing instructions that when executed cause the processor to receive, from one or more sensors, at least one sensor signal representing one or more fire-related conditions surrounding the autonomous vehicle, identify one or more fire-indicative conditions surrounding the autonomous vehicle based on the one or more fire-related conditions, generate a fire detection signal based at least on the one or more fire-indicative conditions, a location of the one or more fire-indicative conditions, and a location of the autonomous vehicle, and transmit the fire detection signal to an external receiver.

Various refinements exist of the features noted in relation to the above-mentioned aspects. Further features may also be incorporated in the above-mentioned aspects as well. These refinements and additional features may exist individually or in any combination. For instance, various features discussed below in relation to any of the illustrated examples may be incorporated into any of the above-described aspects, alone or in any combination.

### BRIEF DESCRIPTION OF DRAWINGS

The following drawings form part of the present specification and are included to further demonstrate certain aspects of the present disclosure. The disclosure may be better understood by reference to one or more of these drawings in combination with the detailed description of specific embodiments presented herein.

FIG. 1 is a top view of a vehicle on a road, the vehicle including an embodiment of a fire detection system.

FIG. 2 is a schematic of a processing system for use with a vehicle including a fire detection system.

FIG. 3 is a flow diagram of a method for detecting and reporting fires by a vehicle.

Corresponding reference characters indicate corresponding parts throughout the several views of the drawings. Although specific features of various examples may be shown in some drawings and not in others, this is for convenience only. Any feature of any drawing may be referenced or claimed in combination with any feature of any other drawing.

### DETAILED DESCRIPTION

The following detailed description and examples set forth preferred materials, components, and procedures used in accordance with the present disclosure. This description and these examples, however, are provided by way of illustration only, and nothing therein shall be deemed to be a limitation upon the overall scope of the present disclosure.

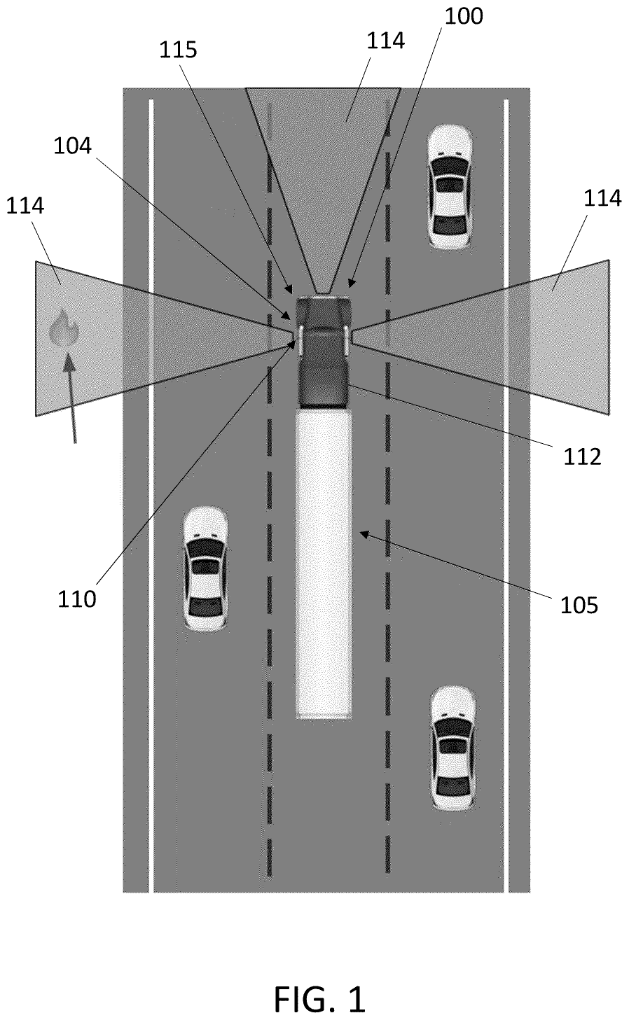

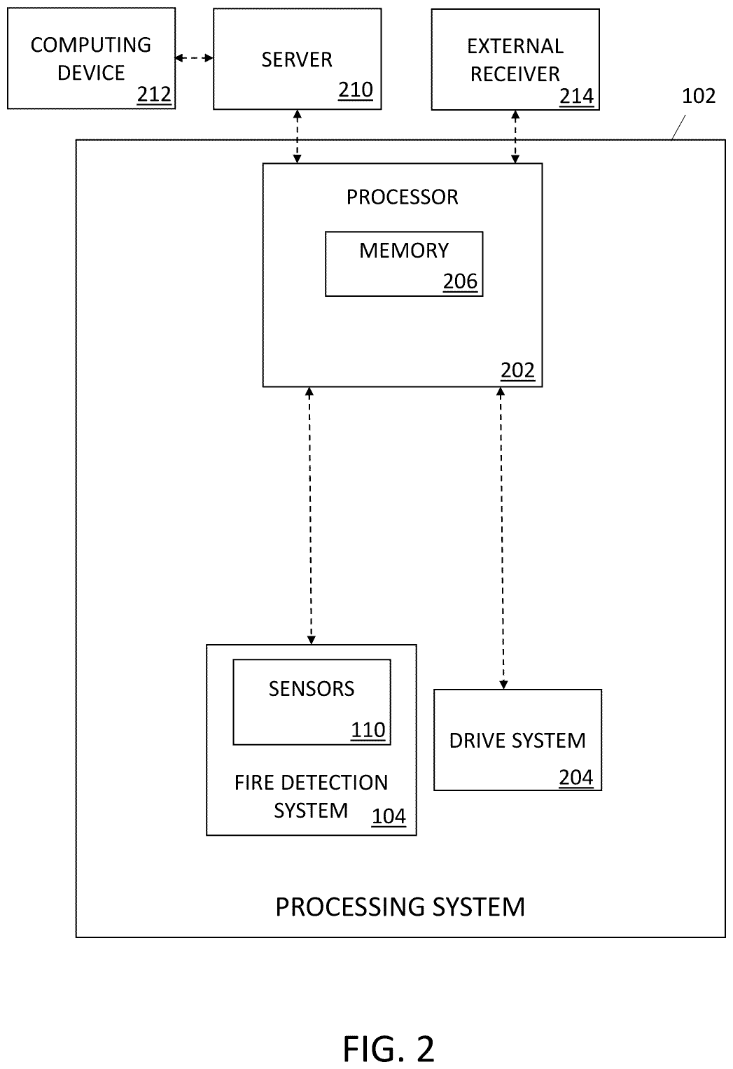

FIG. 1 is a top view of a vehicle 100 on a road. The vehicle 100 is configured for autonomous operation via a processing system 102 (shown in FIG. 2). The vehicle 100 includes a fire detection system 104 for perceiving conditions in one or more areas surrounding the vehicle 100, including, but not limited to, fire-related conditions and fire-indicative conditions. The processing system 102 may be used to control the vehicle 100 based on the fire-related conditions and/or the fire-indicative conditions, such as to control movement of the vehicle 100, plan movement of the vehicle 100, and/or transmit a fire detection signal to a local authority and/or a control center.

The fire detection system 104 includes one or more sensors 110 to detect fire-related conditions in one or more areas surrounding the vehicle 100, such as, but not limited to, a color, an illumination level, a smoke amount, a chemical composition, and a temperature. The one or more sensors 110 may be any sensor known in the art that facilitates the collection of data as related to the fire detection system 104. For example, the one or more sensors 110 may include, but are not limited to, one or more cameras for visual detection, particularly one or more infrared cameras for heat detection and/or nighttime visual detection, one or more other optical sensors for visual detection, and/or one or more chemical sensors such as carbon dioxide or carbon monoxide sensors for chemical detection of the fire-related conditions.

The one or more sensors 110 may be oriented along an exterior surface 112 of the vehicle 100 to identify fire-related conditions surrounding the vehicle 100. For example, each of the one or more sensors 110 may be positioned on and/or proximate to the exterior surface 112 of the vehicle 100 and oriented outwards from the exterior surface 112 to collect signal data in a field of view (FOV) 114 exterior to the vehicle 100. The FOV 114 may be any shape corresponding to the type of sensor 110. That is, although the FOV 114 is illustrated as triangular in FIG. 1, this is intended to be illustrative, and is therefore not meant to be limiting. The one or more sensors 110 may include any number of sensors positioned on and/or proximate to any spot along the exterior surface 112 of the vehicle 100, such as along any segment of a cab 115 and/or a trailer 105 of the vehicle 100. That is, although three of the sensors 110 are illustrated in FIG. 1 on opposing side segments and a front segment of the cab 115 of the vehicle 100, this is intended to be illustrative, and is therefore not meant to be limiting.

FIG. 2 is a schematic of the processing system 102 for use with the vehicle 100. The processing system 102 may be used with any embodiment of the fire detection system 104 as described herein. The processing system 102 includes a processor 202 in communication with the fire detection system 104. The processor 202 may also be in communication with a drive system 204 to autonomously control movement of the vehicle 100. The processor 202 may be one or more processing systems. The processor 202 includes a memory 206 and a processor 208. The memory 206 may be any device allowing information such as executable instructions and/or data to be stored and retrieved. The processor 208 may include one or more processing units to retrieve and execute instructions and/or data stored by the memory 206.

The processing system 102 may use signals received from the one or more sensors 110 of the fire detection system 104 to control the drive system 204. Additionally, the processing system 102 may use signals received from a server 210. The server 210 may be in communication with a computing device 212, such as, but not limited to, a user computing device (such as for manual remote control of the fire detection system 104 and/or the drive system 204) and/or another vehicle in communication with the vehicle 100 to send and/or receive signals between vehicles and/or mission control.

The processing system 102 may control the generation and transmission of a fire detection signal based on the one or more fire-indicative conditions identified surrounding the vehicle 100. For example, the generation and transmission of a fire detection signal may be based on one or more fire-indicative conditions in one or more areas surrounding the vehicle 100, as identified by the processor 208 based on one or more fire-related conditions detected in the one or more areas surrounding the vehicle 100 by the one or more sensors 110. The one or more sensors 110 may detect one or more fire-related conditions, such as, but not limited to, a color, an illumination level, a smoke amount, a chemical composition, and/or a temperature in the one or more areas surrounding the vehicle 100. The processor 208 may compare the detected data to threshold data stored in the memory 206 to identify fire-indicative conditions included in the detected fire-related conditions. The fire detection signal may include a time stamp, a location of the vehicle 100, a location of the one or more fire-indicative conditions, and the one or more fire-indicative conditions.

Additionally, for example, the generation and transmission of the fire detection signal may be based on a fire probability assessment. When comparing the detected data to threshold data stored in the memory 206, the processor 208 may also determine a number of sensor signals received from the one or more sensors 110 and/or a number of the one or more sensors 110 from which the sensor signals were received. The fire probability assessment may be a probability calculation completed by the processor 208 to determine a likelihood that the fire-related conditions are fire-indicative conditions. The fire probability assessment may also be an output of a detection module or an output of a processing pipeline (e.g., machine learning module) for one or more of the sensors 110. The fire detection signal may also include the fire probability assessment.

Upon identification of one or more fire-indicative conditions in the one or more areas surrounding the vehicle 100, the processing system 102 may control the generation of a fire detection signal to alert a local authority and/or a control center of the unsafe conditions detected by the vehicle 100. The fire detection signal may include the one or more fire-indicative conditions, a location of each of the one or more fire-indicative conditions, and a location of the autonomous vehicle. The processing system 102 may also control the transmission of the fire detection signal to an external receiver 214. The external receiver 214 may be a local authority, such as a local authority stationed, and/or a control center configured for further signal dissemination to the local authority. The fire detection signal transmitted to the external receiver 214 may include data in a format for data aggregation, such that the data can be reviewed and/or analyzed by local authorities and/or researchers.

The processing system 102 may also control the motion and/or the motion planning of the vehicle 100 by the drive system 204. For example, the processing system 102 may determine a hazard-response position for the vehicle 100 based on the fire-indicative conditions for safe operation of the vehicle 100 while the fire detection signal is generated and transmitted, such as, but not limited to, a nearby shoulder and/or median of a road and/or a lane of a road furthest from the fire-indicative conditions. Additionally, for example, the processing system 102 may generate a map of one or more routes for the vehicle 100 to continue travel on a route towards the planned destination that is not impeded by the one or more fire-indicative conditions after the fire detection signal has been generated and transmitted.

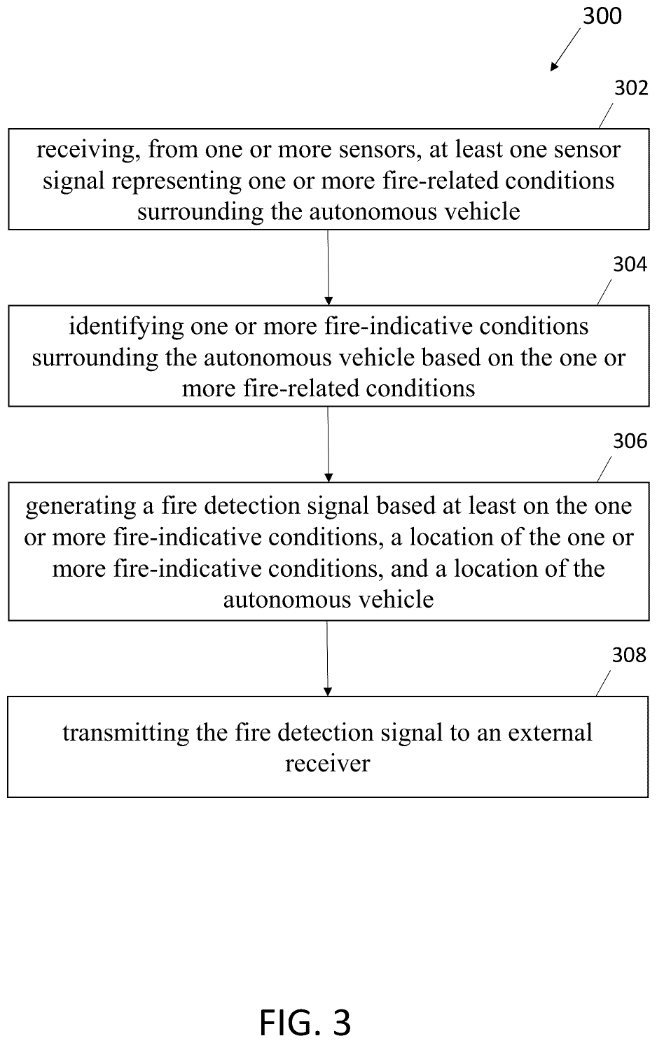

FIG. 3 is a flowchart of a method 300 of detecting and reporting fires by an autonomous vehicle, such as the vehicle 100. The method 300 includes receiving 302, from one or more sensors (such as the one or more sensors 110), at least one sensor signal representing one or more fire-related conditions surrounding the autonomous vehicle, and identifying 304 one or more fire-indicative conditions surrounding the autonomous vehicle based on the one or more fire-related conditions. The method 300 also includes generating 306 a fire detection signal based at least on the one or more fire-indicative conditions, a location of the one or more fire-indicative conditions, and a location of the autonomous vehicle, and transmitting 308 the fire detection signal to an external receiver (such as the external receiver 214).

Some embodiments involve the use of one or more electronic processing or computing devices. As used herein, the terms “processor” and “computer” and related terms, e.g., “processing device,” “computing device,” and “processor” are not limited to just those integrated circuits referred to in the art as a computer, but broadly refers to a processors, a processing device, a controller, a general purpose central processing unit (CPU), a graphics processing unit (GPU), a microcontroller, a microcomputer, a programmable logic controller (PLC), a reduced instruction set computer (RISC) processor, a field programmable gate array (FPGA), a digital signal processor (DSP), an application specific integrated circuit (ASIC), and other programmable circuits or processing devices capable of executing the functions described herein, and these terms are used interchangeably herein. These processing devices are generally “configured” to execute functions by programming or being programmed, or by the provisioning of instructions for execution. The above examples are not intended to limit in any way the definition or meaning of the terms processor, processing device, and related terms.

The various aspects illustrated by logical blocks, modules, circuits, processes, algorithms, and algorithm steps described above may be implemented as electronic hardware, software, or combinations of both. Certain disclosed components, blocks, modules, circuits, and steps are described in terms of their functionality, illustrating the interchangeability of their implementation in electronic hardware or software. The implementation of such functionality varies among different applications given varying system architectures and design constraints. Although such implementations may vary from application to application, they do not constitute a departure from the scope of this disclosure.

Aspects of embodiments implemented in software may be implemented in program code, application software, application programming interfaces (APIs), firmware, middleware, microcode, hardware description languages (HDLs), or any combination thereof. A code segment or machine-executable instruction may represent a procedure, a function, a subprogram, a routine, a subroutine, a module, a software package, a class, or any combination of instructions, data structures, or program statements. A code segment may be coupled to, or integrated with, another code segment or a electronic hardware by passing or receiving information, data, arguments, parameters, memory contents, or memory locations. Information, arguments, parameters, data, etc. may be passed, forwarded, or transmitted via any suitable means including memory sharing, message passing, token passing, network transmission, etc.

The actual software code or specialized control hardware used to implement these systems and methods is not limiting of the claimed features or this disclosure. Thus, the operation and behavior of the systems and methods were described without reference to the specific software code being understood that software and control hardware can be designed to implement the systems and methods based on the description herein.

When implemented in software, the disclosed functions may be embodied, or stored, as one or more instructions or code on or in memory. In the embodiments described herein, memory may include, but is not limited to, a non-transitory computer-readable medium, such as flash memory, a random access memory (RAM), read-only memory (ROM), erasable programmable read-only memory (EPROM), electrically erasable programmable read-only memory (EEPROM), and non-volatile RAM (NVRAM). As used herein, the term “non-transitory computer-readable media” is intended to be representative of any tangible, computer-readable media, including, without limitation, non-transitory computer storage devices, including, without limitation, volatile and non-volatile media, and removable and non-removable media such as a firmware, physical and virtual storage, CD-ROM, DVD, and any other digital source such as a network, a server, cloud system, or the Internet, as well as yet to be developed digital means, with the sole exception being a transitory propagating signal. The methods described herein may be embodied as executable instructions, e.g., “software” and “firmware,” in a non-transitory computer-readable medium. As used herein, the terms “software” and “firmware” are interchangeable, and include any computer program stored in memory for execution by personal computers, workstations, clients, and servers. Such instructions, when executed by a processor, configure the processor to perform at least a portion of the disclosed methods.

As used herein, an element or step recited in the singular and proceeded with the word “a” or “an” should be understood as not excluding plural elements or steps unless such exclusion is explicitly recited. Furthermore, references to “one embodiment” of the disclosure or an “exemplary embodiment” are not intended to be interpreted as excluding the existence of additional embodiments that also incorporate the recited features. Likewise, limitations associated with “one embodiment” or “an embodiment” should not be interpreted as limiting to all embodiments unless explicitly recited.

Disjunctive language such as the phrase “at least one of X, Y, or Z,” unless specifically stated otherwise, is generally intended, within the context presented, to disclose that an item, term, etc. may be either X, Y, or Z, or any combination thereof (e.g., X, Y, and/or Z). Likewise, conjunctive language such as the phrase “at least one of X, Y, and Z,” unless specifically stated otherwise, is generally intended, within the context presented, to disclose at least one of X, at least one of Y, and at least one of Z.

The disclosed systems and methods are not limited to the specific embodiments described herein. Rather, components of the systems or steps of the methods may be utilized independently and separately from other described components or steps.

This written description uses examples to disclose various embodiments, which include the best mode, to enable any person skilled in the art to practice those embodiments, including making and using any devices or systems and performing any incorporated methods. The patentable scope is defined by the claims and may include other examples that occur to those skilled in the art. Such other examples are intended to be within the scope of the claims if they have structural elements that do not differ from the literal language of the claims, or if they include equivalent structural elements with insubstantial differences form the literal language of the claims.

1. A system for detecting and reporting fires by an autonomous vehicle, the autonomous vehicle having an exterior, the system comprising:
a fire detection system comprising one or more sensors oriented outwards from the exterior of the autonomous vehicle to collect data in one or more areas surrounding the autonomous vehicle; and
a processing system, the processing system including a processor and a memory device, the memory device storing instructions that when executed cause the processor to:
receive, from the one or more sensors, at least one sensor signal representing one or more fire-related conditions surrounding the autonomous vehicle;
identify one or more fire-indicative conditions surrounding the autonomous vehicle based on the one or more fire-related conditions;
generate a fire detection signal based at least on the one or more fire-indicative conditions, a location of the one or more fire-indicative conditions, and a location of the autonomous vehicle; and
transmit the fire detection signal to an external receiver.

2. The system of claim 1, wherein the system further comprises a drive system configured to move the autonomous vehicle, the processor being further caused to control the drive system to move the autonomous vehicle into a hazard-response position.

3. The system of claim 1, wherein the external receiver comprises at least one of a local authority and a control center configured for further signal dissemination to the local authority.

4. The system of claim 1, wherein the one or more sensors comprise a camera configured for visual detection of the one or more fire-related conditions, the one or more fire-related conditions comprising at least one of a color, an illumination level, and a smoke amount.

5. The system of claim 1, wherein the one or more sensors comprise an infrared camera configured for heat detection of the one or more fire-related conditions, the one or more fire-related conditions comprising a temperature.

6. The system of claim 5, wherein the infrared camera is further configured for nighttime visual detection of the one or more fire-related conditions, the one or more fire-related conditions comprising at least one of an illumination level and a smoke amount.

7. The system of claim 1, wherein the one or more sensors comprise a chemical sensor configured for chemical detection of the one or more fire-related conditions, the one or more fire-related conditions comprising at least one of a carbon dioxide amount and a carbon monoxide amount.

8. The system of claim 1, wherein the fire detection signal comprises at least one of a time, a location of the autonomous vehicle, a location of the one or more fire-indicative conditions, the one or more fire-indicative conditions, and a fire probability assessment.

9. The system of claim 8, wherein the fire probability assessment is based on at least one of a light threshold amount, a smoke threshold amount, and a threshold temperature.

10. The system of claim 9, wherein the fire probability assessment is further based on a number of sensor signals received and a number of the one or more sensors from which sensor signals were received.

11. A method for detecting and reporting fires by an autonomous vehicle, the method comprising:
receiving, from one or more sensors, at least one sensor signal representing one or more fire-related conditions surrounding the autonomous vehicle;
identifying one or more fire-indicative conditions surrounding the autonomous vehicle based on the one or more fire-related conditions;
generating a fire detection signal based at least on the one or more fire-indicative conditions, a location of the one or more fire-indicative conditions, and a location of the autonomous vehicle; and
transmitting the fire detection signal to an external receiver.

12. The method of claim 11, further comprising controlling a drive system configured to move the autonomous vehicle into a hazard-response position.

13. The method of claim 11, wherein transmitting the fire detection signal to the external receiver comprises transmitting to at least one of a local authority and a control center configured for further signal dissemination to the local authority.

14. The method of claim 11, wherein receiving from the one or more sensors comprises receiving visual detection signal data from a camera, the one or more fire-related conditions comprising at least one of a color, an illumination level, and a smoke amount.

15. The method of claim 11, wherein receiving from the one or more sensors comprises receiving heat detection signal data from an infrared camera, the one or more fire-related conditions comprising a temperature.

16. The method of claim 15, wherein receiving from the one or more sensors further comprises receiving nighttime visual detection signal data from the infrared camera, the one or more fire-related conditions comprising at least one of an illumination level and a smoke amount.

17. The method of claim 11, wherein the one or more sensors comprise a chemical sensor configured for chemical detection of the one or more fire-related conditions, the one or more fire-related conditions comprising at least one of a carbon dioxide amount and a carbon monoxide amount.

18. The method of claim 11, wherein transmitting the fire detection signal comprises transmitting at least one of a time, a location of the autonomous vehicle, a location of the one or more fire-indicative conditions, the one or more fire-indicative conditions, and a fire probability assessment, the fire probability assessment being based on at least one of a light threshold amount, a smoke threshold amount, and a threshold temperature.

19. The method of claim 18, wherein transmitting the fire probability assessment is further based on a number of sensor signals received and a number of the one or more sensors from which sensor signals were received.

20. A processing system for detecting and reporting fires by an autonomous vehicle, the processing system comprising a processor and a memory device, the memory device storing instructions that when executed cause the processor to:
receive, from one or more sensors, at least one sensor signal representing one or more fire-related conditions surrounding the autonomous vehicle;
identify one or more fire-indicative conditions surrounding the autonomous vehicle based on the one or more fire-related conditions;
generate a fire detection signal based at least on the one or more fire-indicative conditions, a location of the one or more fire-indicative conditions, and a location of the autonomous vehicle; and
transmit the fire detection signal to an external receiver.
